(19) United States
(12) Patent Application Publication
(10) Pub. No.: US 2017/0098902 A1
(43) Pub. Date: Apr. 6, 2017

(54) MEMORY CARD CONNECTOR

(71) Applicant: KYOCERA Connector Products Corporation, Yokohama-shi, Kanagawa (JP)

(72) Inventors: Toru WAGATSUMA, Yokohama-shi, Kanagawa (JP); Hengfeng LU, Sagamihara-shi, Kanagawa (JP)

(73) Assignee: KYOCERA Connector Products Corporation, Yokohama-shi, Kanagawa (JP)

(21) Appl. No.: 15/315,989

(22) PCT Filed: Apr. 27, 2015
(86) PCT No.: PCT/JP2015/062666

§ 371 Date: Dec. 2, 2016

(30) Foreign Application Priority Data
Jun. 9, 2014 (JP) 2014-118675

(51) Int. Cl. H01R 12/70; H01R 12/71

(52) U.S. Cl. CPC H01R 12/7076; H01R 12/7005; H01R 12/716

(57) ABSTRACT

A memory card connector includes: an insulator (63) having a card storage space (68) into and from which a memory card (SC) is insertable and removable, and a bottom plate portion (64) forming a bottom surface of the card storage space; and a contact (25) having a contact portion (32) that comes into contact with a terminal (SC1) of the memory card inserted in the card storage space, and a pair of elastic deformation portions (26, 29) each of which has one end connected to the contact portion and an other end supported by a support portion (20, 22), wherein in one elastic deformation portion, the other end is located more in an insertion direction than the one end, and at least a part is different in position from the contact portion in a direction orthogonal to a linear direction and a thickness direction of the memory card, and in the other elastic deformation portion, the other end is located more in a removal direction than the one end.

### TECHNICAL FIELD

The disclosure relates to a memory card connector into which a memory card such as a SIM card can be removably inserted.

### BACKGROUND

A conventional technique for this type of memory card connector is disclosed in Patent Literature (PTL) 1 as an example.

The memory card connector includes: a resin insulator that is open in a ceiling portion and at one end in the longitudinal direction and whose internal space forms a card storage space; a metal shell member attached to the ceiling portion of the insulator (to block the ceiling portion); and a contact group of a plurality of metal contacts fixed to a bottom plate portion of the insulator.

Each contact includes: a fixed portion fixed to the bottom plate portion; a contact piece extending from the fixed portion toward the card storage space (upward) along the longitudinal direction of the insulator; and a tail piece extending from the fixed portion toward the outside of the insulator.

The memory card connector can be mounted on a circuit board (rigid board) by, in a state where the bottom plate portion of the insulator faces the circuit board in parallel with the circuit board, soldering each tail piece of the contact group to a circuit pattern of the circuit board.

In PTL 1, a memory card can be inserted into the card storage space of the connector by linearly moving the memory card along the longitudinal direction of the insulator. When the memory card is inserted in the card storage space, a plurality of terminals formed in the memory card come into contact with the contact pieces of the respective contacts. The memory card and the circuit board (circuit pattern) are thus brought into electric conduction with each other through the contact group.

### CITATION LIST

### Patent Literature

PTL 1: JP 2007-157524 A

### SUMMARY

### Technical Problem

The contact piece of each contact in the contact group has a cantilever structure in which only one end (fixed portion) is supported by the bottom plate portion and the other end is a free end. Accordingly, in the case where the memory card is inserted into or removed from the card storage space of the connector in an abnormal position deviating from the normal position or the plate thickness of the memory card is large, there is a possibility that an excessive force is exerted on the contact piece of each contact from the memory card and causes the contact piece to be plastically deformed. If the contact piece of each contact is plastically deformed, the contact pressure between the contact piece and the memory card (terminal) decreases, which may lead to poor contact between the contact piece and the memory card (terminal).

This problem can be solved by, for example, forming each contact to have the structure illustrated in FIG. 11. This contact includes: a contact portion located in the card storage space (separated upward from the bottom plate portion) and extending in the longitudinal direction of the insulator (the memory card insertion/removal direction); and a pair of elastic deformation portions extending from both ends of the contact portion toward the opposite sides from each other and having their ends opposite to the contact portion fixed to the bottom plate portion. As illustrated, when seen in the thickness direction of the memory card (vertical direction), the pair of elastic deformation portions extend in a direction parallel to the longitudinal direction of the insulator (both elastic deformation portions are on the same straight line). When seen in a direction (horizontal direction) orthogonal to the thickness direction of the memory card, on the other hand, the pair of elastic deformation portions extend diagonally down from the contact portion toward the bottom plate portion.

Such a contact has a double-support structure in which the ends of the pair of elastic deformation portions are both supported by the bottom plate portion. Accordingly, even in the case where an excessive force is exerted on the contact portion of each contact from the memory card (such as when the memory card is inserted into or removed from the card storage space of the connector in an abnormal position), the elastic deformation portions (and the contact portion) are unlikely to be plastically deformed.

Reductions in size of electronic devices (e.g. mobile terminals such as smartphones and tablet computers) including memory card connectors in recent years have created the need to reduce the size of memory card connectors in the longitudinal direction of the insulator. This requires the dimension (in the longitudinal direction) of the pair of elastic deformation portions of each contact to be reduced as compared with the conventional technique.

However, shortening the elastic deformation portions makes the elastic deformation portions less elastically deformable, and causes a decrease in the followability of the elastic deformation portions with respect to the memory card (terminal). In detail, it becomes difficult to ensure the amount of elastic displacement necessary to absorb the rattling of the memory card connector and memory card or the thickness tolerance of the memory card. This is likely to result in poor contact between the elastic deformation portions and the memory card (terminal).

It could therefore be helpful to provide a memory card connector that has a contact capable of resisting a plastic deformation due to a force exerted from a memory card and prevents a decrease in the followability of the contact with respect to the memory card, even in the case where the connector is reduced in size.

### Solution to Problem

A memory card connector including: a resin insulator having a card storage space into which a memory card is insertable along a linear direction and from which the memory card is removable along the linear direction, and a bottom plate portion forming a bottom surface of the card storage space; and a metal contact having a contact portion that comes into contact with a terminal of the memory card inserted in the card storage space and at least a part of which is located in the card storage space above the bottom plate portion, and a pair of elastic deformation portions each of which has one end connected to the contact portion and an other end supported by a support portion that is formed by the bottom plate portion or by a fixed portion fixed to the bottom plate portion, wherein in one of the pair of elastic deformation portions, the other end is located more in a direction in which the memory card is inserted than the one end, and at least a part is different in position from the contact portion in a direction orthogonal to the linear direction and a thickness direction of the memory card, and in an other one of the pair of elastic deformation portions, the other end is located more in a direction in which the memory card is removed than the one end, and at least a part is different in position from the contact portion in the orthogonal direction.

The contact portion may be elastically deformable in the thickness direction of the memory card.

The contact portion may extend along the linear direction when seen in the thickness direction of the memory card.

Both ends of the contact portion may be each closer to the support portion than an intermediate portion of the contact portion in the linear direction.

The one end of each of the pair of elastic deformation portions may be separated from the support portion in the thickness direction of the memory card.

The bottom plate portion may have a bottom through hole, a part of the contact may be located in the bottom through hole, and at least a part of the contact portion may be located in the card storage space.

The one of the pair of elastic deformation portions may have a first deformation portion extending from the other end toward the contact portion in the direction in which the memory card is removed, and a second deformation portion extending from an end of the first deformation portion opposite to the other end in the orthogonal direction and having an end opposite to the first deformation portion forming the one end, the other one of the pair of elastic deformation portions may have a third deformation portion extending from the other end toward the contact portion in the direction in which the memory card is inserted, and a fourth deformation portion extending from an end of the third deformation portion opposite to the other end in the orthogonal direction and having an end opposite to the third deformation portion forming the one end, and the second deformation portion may be located more in the direction in which the memory card is removed, than the fourth deformation portion.

### Advantageous Effect

The memory card connector has a double-support structure including: the contact portion that comes into contact with the terminal of the memory card; and the pair of elastic deformation portions each of which has one end connected to the contact portion and the other end supported by the support portion. Hence, even in the case where the connector and the contact are reduced in size (in the direction in which the memory card is inserted into or removed from the connector), the contact resists a plastic deformation when an excessive force is exerted on the contact from the memory card.

Moreover, since the pair of elastic deformation portions are not in a simple linear shape extending in the memory card insertion/removal direction, the whole length of the pair of elastic deformation portions (spring length) can be long even in the case where the entire contact is reduced in size (in the direction in which the memory card is inserted into or removed from the connector). Thus, even in the case where the connector and the contact are reduced in size (in the direction in which the memory card is inserted into or removed from the connector), a sufficient amount of elastic displacement of the contact (elastic deformation portions) is easily ensured, and so a decrease in the followability of the contact with respect to the memory card can be prevented.

### BRIEF DESCRIPTION OF THE DRAWINGS

In the accompanying drawings:

FIG. 1 is a perspective view of a connector (from which a shell member has been separated) according to one of the disclosed embodiments and a SIM card as seen obliquely from front above;

FIG. 2 is a plan view of the connector from which the shell member has been omitted;

FIG. 3 is a perspective view of a metal integral member as seen from above;

FIG. 4 is an enlarged perspective view of a first contact block;

FIG. 5 is an enlarged side view of part of the first contact block;

FIG. 6 is an enlarged front view of part of the first contact block;

FIG. 7 is an enlarged front view of part of the connector;

FIG. 8 is a plan view of a contact according to a first modification;

FIG. 9 is a plan view of a contact according to a second modification;

FIG. 10 is a plan view of a contact according to a third modification; and

FIG. 11 is a plan view of a conventional contact.

### DETAILED DESCRIPTION

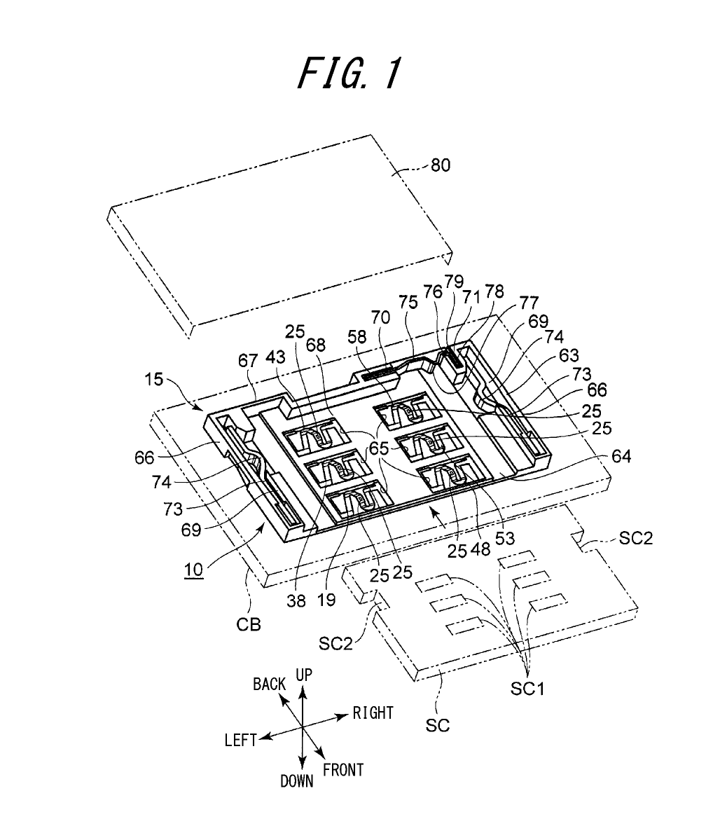

One of the disclosed embodiments is described below, with reference to FIGS. 1 to 7. The directions of front, back, up, down, right, and left in the following description are based on the arrow directions illustrated in the drawings.

A memory card connector 10 in this embodiment is a connector for a SIM card SC which can be removably attached to a mobile terminal such as a smartphone.

The memory card connector 10 includes a lower housing 15 and a shell member 80 as main components.

The lower housing 15 which is substantially rectangular in a plan view includes a metal integral member 16, an insulator 63, a first detection spring 75, and a second detection spring 78.

A left portion constituent piece 17, a right portion constituent piece 18, a first contact block 19, a second contact block 38, a third contact block 43, a fourth contact block 48, a fifth contact block 53, and a sixth contact block 58 are obtained by press forming one metal plate (see FIG. 3). Immediately after press forming these metal members, the adjacent members of the left portion constituent piece 17, right portion constituent piece 18, first contact block 19, second contact block 38, third contact block 43, fourth contact block 48, fifth contact block 53, and sixth contact block 58 are connected to each other by a cutoff bridge (not illustrated), and so these metal members constitute part of the metal integral member 16.

The left portion constituent piece 17 and the right portion constituent piece 18 are flat plates located in the same plane.

The first contact block 19 integrally includes: a right fixed portion 20 and a left fixed portion 22 located in the same plane as the left portion constituent piece 17 and the right portion constituent piece 18; a contact 25 located between the right fixed portion 20 and the left fixed portion 22; a tail connection piece 35; and a tail piece 36.

The right fixed portion 20 includes a support protrusion piece 21 extending left, in the back portion of its left edge. The left fixed portion 22 includes a support protrusion piece 23 extending right, in the front portion of its right edge.

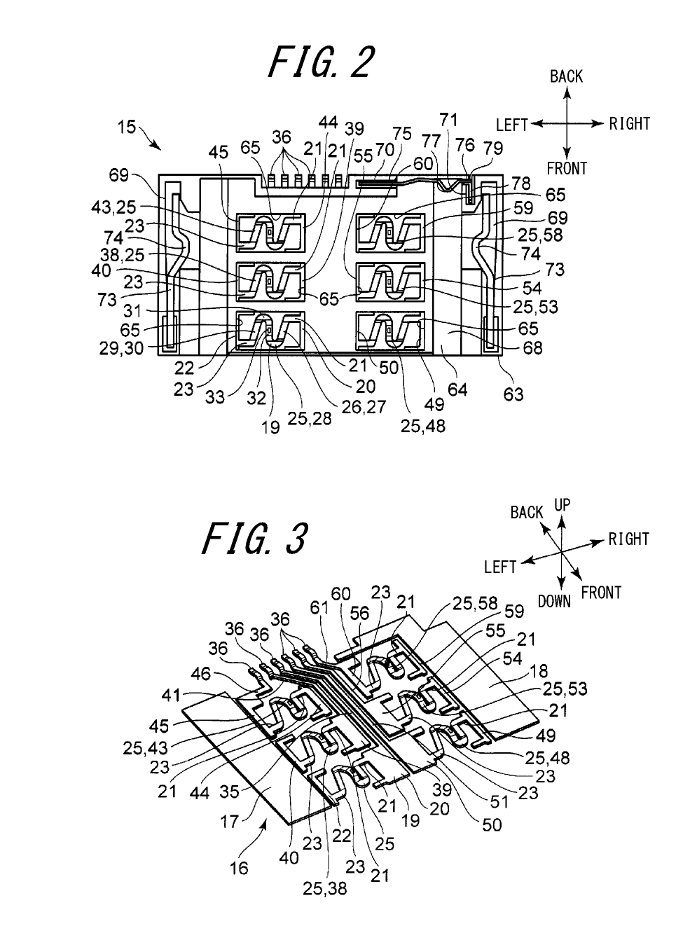

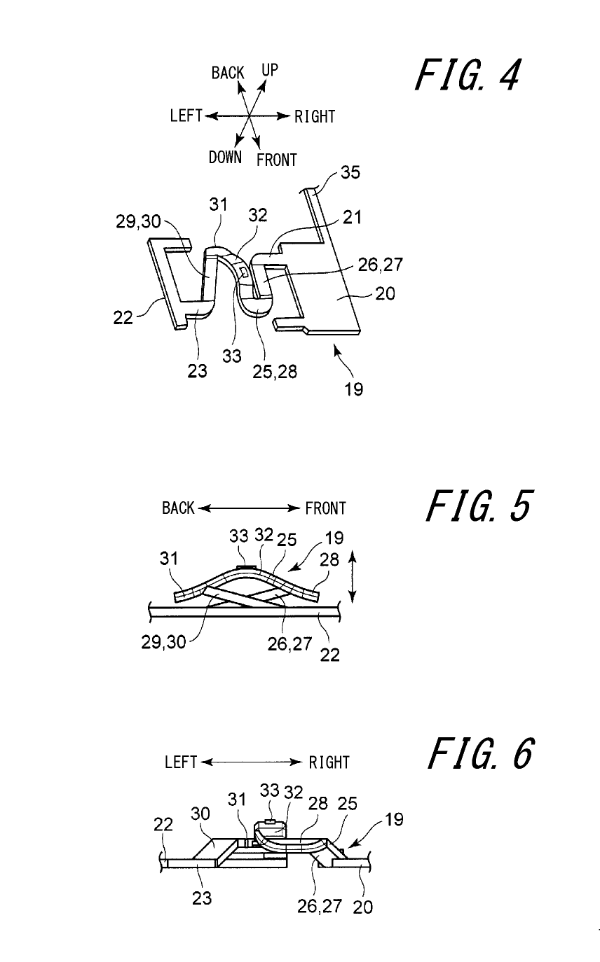

The contact 25 located between the support protrusion piece 21 of the right fixed portion 20 and the support protrusion piece 23 of the left fixed portion 22 is integral with the support protrusion piece 21 and the support protrusion piece 23. The contact 25 includes a first elastic deformation portion 26 made up of: a first deformation portion 27 extending diagonally forward left from the left end of the support protrusion piece 21; and a second deformation portion 28 extending left (in a direction orthogonal to the front-back direction and the thickness direction of the SIM card SC, which may be a substantially orthogonal direction that is included in the “orthogonal direction” in the claims, the same definition applying to a fourth deformation portion 31) from the front end of the first deformation portion 27. The contact 25 also includes a second elastic deformation portion 29 made up of: a third deformation portion 30 extending diagonally back right from the right end of the support protrusion piece 23; and the fourth deformation portion 31 extending right (in the orthogonal direction) from the back end of the third deformation portion 30. The left end of the second deformation portion 28 and the right end of the fourth deformation portion 31 are at the same position in the right-left direction, as illustrated in FIG. 2. The contact 25 further includes a contact portion 32 connecting between the left end of the second deformation portion 28 and the right end of the fourth deformation portion 31 and extending in the front-back direction in a plan view. The side shape of the contact portion 32 is inverted V, with its center in the longitudinal direction being situated highest, as illustrated in FIG. 5. As illustrated, the left end of the second deformation portion 28 is connected to the front end of the contact portion 32, and the right end of the fourth deformation portion 31 is connected to the back end of the contact portion 32. The contact portion 32 integrally has a contact projection 33 at the center of its upper surface in the longitudinal direction, as illustrated in FIGS. 4, 5, etc. The first elastic deformation portion 26, the second elastic deformation portion 29, and the contact portion 32 are all elastically deformable in the up-down direction. Here, the first elastic deformation portion 26 and the second elastic deformation portion 29 are more elastically deformable than the contact portion 32 (when a force of the same magnitude is applied, the first elastic deformation portion 26 and the second elastic deformation portion 29 have a larger elastic deformation than the contact portion 32).

The first contact block 19 includes the tail connection piece 35 linearly extending back from the right fixed portion 20 and then extending diagonally back left. The first contact block 19 also includes the tail piece 36 protruding back from the back end of the tail connection piece 35 and situated one step lower than the left portion constituent piece 17, the right portion constituent piece 18, the right fixed portion 20, and the left fixed portion 22.

The second contact block 38 integrally includes: a right fixed portion 39 and a left fixed portion 40 respectively situated just behind the right fixed portion 20 and the left fixed portion 22 and located in the same plane as the right fixed portion 20 and the left fixed portion 22; a contact 25 located between a support protrusion piece 21 protruding from the right fixed portion 39 and a support protrusion piece 23 protruding from the left fixed portion 40; a tail connection piece 41 linearly extending back from the right fixed portion 39 and then extending diagonally back left; and a tail piece 36 protruding from the back end of the tail connection piece 41.

The third contact block 43 integrally includes: a right fixed portion 44 and a left fixed portion 45 respectively situated just behind the right fixed portion 39 and the left fixed portion 40 and located in the same plane as the right fixed portion 20 and the left fixed portion 22; a contact 25 located between a support protrusion piece 21 protruding from the right fixed portion 44 and a support protrusion piece 23 protruding from the left fixed portion 45; a tail connection piece 46 extending right from the left fixed portion 45 and then extending back; and a tail piece 36 protruding from the back end of the tail connection piece 46.

The fourth contact block 48 integrally includes: a right fixed portion 49 and a left fixed portion 50 situated on the right side of the right fixed portion 20 and located in the same plane as the right fixed portion 20 and the left fixed portion 22; a contact 25 located between a support protrusion piece 21 protruding from the right fixed portion 49 and a support protrusion piece 23 protruding from the left fixed portion 50; a tail connection piece 51 linearly extending back from the left fixed portion 50 and then extending diagonally back left; and a tail piece 36 protruding from the back end of the tail connection piece 51.

The fifth contact block 53 integrally includes: a right fixed portion 54 and a left fixed portion 55 respectively situated just behind the right fixed portion 49 and the left fixed portion 50 and located in the same plane as the right fixed portion 20 and the left fixed portion 22; a contact 25 located between a support protrusion piece 21 protruding from the right fixed portion 54 and a support protrusion piece 23 protruding from the left fixed portion 55; a tail connection piece 56 linearly extending back from the left fixed portion 55 and then extending diagonally back left; and a tail piece 36 protruding from the back end of the tail connection piece 56.

The sixth contact block 58 integrally includes: a right fixed portion 59 and a left fixed portion 60 respectively situated just behind the right fixed portion 54 and the left fixed portion 55 and located in the same plane as the right fixed portion 20 and the left fixed portion 22; a contact 25 located between a support protrusion piece 21 protruding from the right fixed portion 59 and a support protrusion piece 23 protruding from the left fixed portion 60; a tail connection piece 61 extending diagonally back left from the left fixed portion 60; and a tail piece 36 protruding from the back end of the tail connection piece 61.

The insulator 63 made of a resin material having insulation property and heat resistance property is integrated with the metal integral member 16, by performing outsert molding on the metal integral member 16 in a mold (not illustrated). The insulator 63 is a box member whose upper surface and front surface are open. A total of six bottom through holes 65 rectangular in a plan view are arranged in a bottom plate portion 64 that forms the bottom surface of the insulator 63. The space surrounded by the right and left side walls 66, back wall 67, and bottom plate portion 64 of the insulator 63 forms a card storage space 68. A lock spring storage groove 69 extending in the front-back direction and communicating with the card storage space 68 is formed in the upper surface of each of the right and left side walls 66. A first detection spring storage groove 70 and a second detection spring storage groove 71 are formed respectively in the upper surfaces of the back wall 67 and right side wall 66.

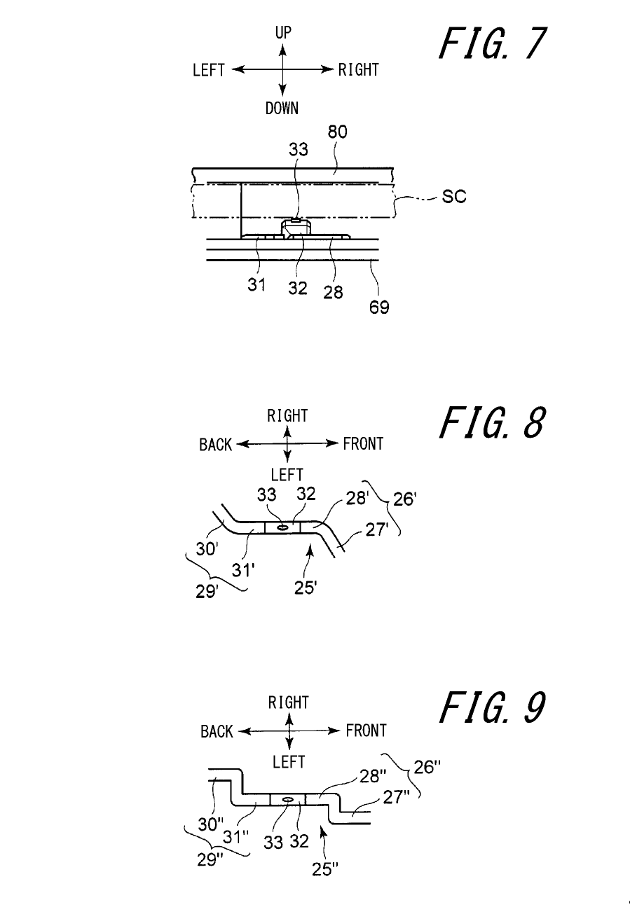

As illustrated, part of each of the first contact block 19, second contact block 38, third contact block 43, fourth contact block 48, fifth contact block 53, and sixth contact block 58 of the metal integral member 16, namely, part of each of the right fixed portion 20, left fixed portion 22, right fixed portion 39, left fixed portion 40, right fixed portion 44, left fixed portion 45, right fixed portion 49, left fixed portion 50, right fixed portion 54, left fixed portion 55, right fixed portion 59, and left fixed portion 60, each tail piece 36, and each contact 25, is located in the corresponding bottom through hole 65, and all other parts are buried (fixed) inside the insulator 63 (covered by the insulator 63). As illustrated in FIG. 7, the contact portion 32 (contact projection 33) and part of the second deformation portion 28 and fourth deformation portion 31 of the contact 25 in the free state are higher than (above) the upper surface of the bottom plate portion 64 when the memory card connector 10 is seen in the horizontal direction.

Moreover, a circular through hole is formed in the bottom plate portion 64 at the position corresponding to each cutoff bridge, although not illustrated. After outsert molding the insulator 63, the cutoff bridges of the metal integral member 16 are cut with a cutter using the circular through holes in the bottom plate portion 64, thus separating the left portion constituent piece 17, the right portion constituent piece 18, the first contact block 19, the second contact block 38, the third contact block 43, the fourth contact block 48, the fifth contact block 53, and the sixth contact block 58 from each other.

A lock spring 73 which is a metal plate spring is provided in each of the right and left lock spring storage grooves 69 of the insulator 63. The center portion of the lock spring 73 forms a lock portion 74 protruding toward the card storage space 68. Each of the right and left lock springs 73 is elastically deformable in its plate thickness direction (right-left direction).

A first detection spring 75 and a second detection spring 78 each of which is a metal plate spring are attached respectively to the first detection spring storage groove 70 and second detection spring storage groove 71 of the insulator 63. The first detection spring 75 has its left end fitted into and fixed to the first detection spring storage groove 70, its right end forming a contact piece 76, and its intermediate portion forming a pressed protrusion 77 protruding forward. A contact piece 79 extending left is formed at the back end of the second detection spring 78. Part of the second detection spring 78 other than the contact piece 79 is fitted into and fixed to the second detection spring storage groove 71, with the contact piece 79 being situated just in front of the contact piece 76. When no external force is exerted on the first detection spring 75, the contact piece 76 of the first detection spring 75 comes into contact with the contact piece 79 of the second detection spring 78 from behind. The first detection spring 75 and the second detection spring 78 also include tail pieces (not illustrated) located at the same height as each tail piece 36.

The upper surface and peripheral surface of the lower housing 15 except the front surface are removably covered by the metal shell member 80 (see FIGS. 1 and 7). A plurality of tail pieces (not illustrated) protrude from the lower edges of the shell member 80. These tail pieces are at the same height as each tail piece 36.

The memory card connector 10 having the aforementioned structure is mounted on the upper surface (circuit forming surface) of a circuit board CB (see the imaginary lines in FIG. 1). In detail, a suction means (not illustrated) located above the memory card connector 10 is attached to the upper surface of the shell member 80. The suction means is moved to place each tail piece 36 on solder paste applied to a circuit pattern on the circuit board CB, each tail piece of the first detection spring 75 and second detection spring 78 on solder paste applied to an insertion state detection circuit pattern (insertion state detection circuit) on the circuit board CB, and each tail piece of the shell member 80 on solder paste applied to a ground pattern on the circuit board CB. Each solder paste is then heated to melt in a reflow furnace, to solder each tail piece 36, each tail piece of the first detection spring 75 and second detection spring 78, and each tail piece of the shell member 80 to the corresponding pattern.

The operation when the SIM card SC is inserted into or removed from the memory card connector 10 having the aforementioned structure is described below.

Six terminals SC1 are formed on the lower surface of the SIM card SC whose planar shape is substantially a rectangle longer in the right-left direction. In addition, an engagement recess SC2 is formed on each of the right and left sides of the SIM card SC. When the contact 25 (the first elastic deformation portion 26, the second elastic deformation portion 29, and the contact portion 32) is in the free state (when the SIM card SC is not inserted in the memory card connector 10), the thickness of the SIM card SC is slightly greater than the distance in the up-down direction between the contact projection 33 of each contact 25 and the lower surface of the shell member 80.

When the SIM card SC is not inserted in the memory card connector 10, the contact piece 76 of the first detection spring 75 comes into contact with the contact piece 79 of the second detection spring 78 from behind. The insertion state detection circuit pattern formed on the circuit board CB accordingly transmits a detection signal to a controller of the mobile terminal, and the controller detects that the SIM card SC is not inserted in the mobile terminal (the memory card connector 10).

When the SIM card SC located just in front of the front opening of the memory card connector 10 is moved in the linear direction (front-back direction) from the front opening toward the back of the card storage space 68 to be inserted into the card storage space 68 (see FIG. 7), the right and left lock springs 73 slidingly come into contact with the side surfaces of the SIM card SC and elastically deform outward, and their lock portions 74 engage with the right and left engagement recesses SC2. Once the SIM card SC has been inserted into the card storage space 68, the storage state of the SIM card SC in the card storage space 68 is maintained unless the SIM card SC is intentionally pulled out forward in the linear direction (front-back direction). Moreover, each terminal SC1 of the SIM card SC inserted in the card storage space 68 comes into contact with the contact projection 33 of the contact portion 32 of the corresponding contact 25 from above. The SIM card SC and the circuit board CB are thus brought into electric conduction with each other through the first contact block 19, the second contact block 38, the third contact block 43, the fourth contact block 48, the fifth contact block 53, and the sixth contact block 58.

Here, since a downward force is exerted on the contact projection 33 of the contact portion 32 (of each contact 25) from the SIM card SC sandwiched between the lower surface of the shell member 80 and the contact projection 33, the first elastic deformation portion 26 and the second elastic deformation portion 29 (and the contact portion 32) elastically deform downward (the inclination angle of each of the first deformation portion 27 and third deformation portion 30 with respect to the bottom plate portion 64 decreases). If the plate thickness of the SIM card SC is large or the position of the SIM card SC deviates from the normal position (for example, the SIM card SC is inclined with respect to the surface of the circuit board CB in a side view), a large force is supposed to be exerted on each contact 25 from the SIM card SC. However, since each contact 25 has a double-support structure in which the contact portion 32 is supported by the bottom plate portion 64 through the first elastic deformation portion 26 and the second elastic deformation portion 29, the first elastic deformation portion 26 and second elastic deformation portion 29 of each contact 25 are unlikely to be plastically deformed even in the case where the memory card connector 10 (and the contact 25) is reduced in size in the front-back direction. Further, since the contact portion 32 extends in the front-back direction in a plan view, the contact portion 32 is unlikely to be plastically deformed (e.g. buckled) even when subjected to a large force from the SIM card SC moving in the front-back direction.

The first elastic deformation portion 26 of the contact 25 includes the first deformation portion 27 and the second deformation portion 28 that cross each other in a plan view, and the second elastic deformation portion 29 of the contact 25 includes the third deformation portion 30 and the fourth deformation portion 31 that cross each other in a plan view. In other words, the first elastic deformation portion 26 and second elastic deformation portion 29 of the contact 25 are not in a shape simply extending in the front-back direction (a simple linear shape). Accordingly, the whole length (spring length) of the first elastic deformation portion 26 and second elastic deformation portion 29 can be long even in the case where the entire contact 25 is reduced in size in the front-back direction. Thus, even in the case where the memory card connector 10 (and the contact 25) is reduced in size in the front-back direction, the contact 25 (in particular the first elastic deformation portion 26 and the second elastic deformation portion 29) easily deforms elastically, and so a decrease in the followability of the contact 25 with respect to the SIM card SC (terminal SC1) can be prevented. This ensures that each contact 25 comes into contact with the terminal SC1 of the SIM card SC of any of various thicknesses.

The first elastic deformation portion 26 and the second elastic deformation portion 29 are not in a shape simply extending in the front-back direction (a simple linear shape) but in a shape also extending in the right-left direction. Hence, in the case where a force in the right-left direction is exerted on the contact portion 32 from the SIM card SC when, for example, the SIM card SC is inserted into the memory card connector 10 while being inclined with respect to the front-back direction in a plan view or the inserted SIM card SC is inclined in the memory card connector 10, the first elastic deformation portion 26 and the second elastic deformation portion 29 act to keep the contact portion 32 from moving in the right-left direction from the normal position, thus suppressing misalignment. The contact portion 32 can also be prevented from being plastically deformed in the right-left direction. Contact between the contact portion 32 and the terminal SC1 of the SIM card SC can thus be ensured even in such a case.

In the free state, the contact portion 32 side end of each of the first elastic deformation portion 26 and second elastic deformation portion 29 of the contact 25 is situated higher than the opposite end (the entire first elastic deformation portion 26 and second elastic deformation portion 29 are not in one horizontal plane). This allows the first elastic deformation portion 26 and the second elastic deformation portion 29 to have a large elastic force as compared with the case where the entire first elastic deformation portion 26 and second elastic deformation portion 29 are in one horizontal plane.

When the SIM card SC is inserted in the card storage space 68, the first elastic deformation portion 26 and the second elastic deformation portion 29 are closer to the horizontal state than when the contact 25 is in the free state (the inclination angle of each of the first deformation portion 27 and third deformation portion 30 with respect to the bottom plate portion 64 decreases). Moreover, as illustrated in FIG. 7, only the contact portion 32 (contact projection 33) and part of the second deformation portion 28 and fourth deformation portion 31 of the contact 25 in the free state are higher than (above) the upper surface of the bottom plate portion 64 when the memory card connector 10 is seen in the horizontal direction (the other parts are located in the bottom through hole 65). The height of the memory card connector 10 can thus be reduced (despite the elastic deformability of the contact 25).

When the SIM card SC is inserted in the card storage space 68 of the memory card connector 10, the right portion of the back end surface of the SIM card SC presses back the pressed protrusion 77 of the first detection spring 75. As a result, the contact piece 76 of the first detection spring 75 separates back from the contact piece 79 of the second detection spring 78. This interrupts the transmission of the detection signal from the insertion state detection circuit pattern formed on the circuit board CB to the controller of the mobile terminal. The controller accordingly detects that the SIM card SC is properly inserted in the mobile terminal (the memory card connector 10).

The disclosure is not limited to the embodiment described above, and various modifications are possible.

For example, the contact 25 in each of the first contact block 19, second contact block 38, third contact block 43, fourth contact block 48, fifth contact block 53, and sixth contact block 58 may be changed to the shape illustrated in any of FIGS. 8 to 10.

In a contact 25′ illustrated in FIG. 8, a second deformation portion 28′ extends forward from the front end of the contact portion 32 and a first deformation portion 27′ extends diagonally forward left from the front end of the second deformation portion 28′ in a plan view. Likewise, in the contact 25′, a fourth deformation portion 31′ extends back from the back end of the contact portion 32 and a third deformation portion 30′ extends diagonally back right from the back end of the fourth deformation portion 31′ in a plan view. In a side view of the contact 25′, the first deformation portion 27′, the second deformation portion 28′, the third deformation portion 30′, and the fourth deformation portion 31′ extend diagonally down from the contact portion 32 side to the bottom plate portion 64 side.

In a contact 25″ illustrated in FIG. 9, a second deformation portion 28″ extends forward from the front end of the contact portion 32 and then extends left and a first deformation portion 27″ extends forward from the front end of the second deformation portion 28″ in a plan view. Likewise, in the contact 25″, a fourth deformation portion 31″ extends back from the back end of the contact portion 32 and then extends right and a third deformation portion 30″ extends back from the back end of the fourth deformation portion 31″ in a plan view. In a side view of the contact 25″, the first deformation portion 27″, the second deformation portion 28″, the third deformation portion 30″, and the fourth deformation portion 31″ extend diagonally down from the contact portion 32 side to the bottom plate portion 64 side.

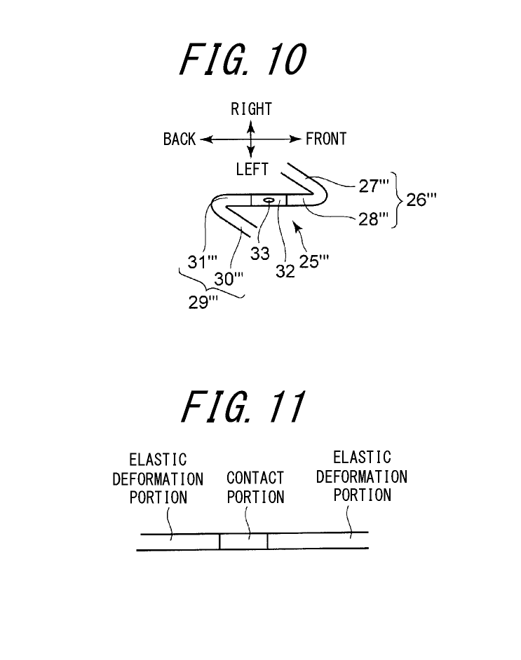

In a contact 25′″ illustrated in FIG. 10, a second deformation portion 28′″ extends forward from the front end of the contact portion 32 and a first deformation portion 27′″ extends diagonally back right from the front end of the second deformation portion 28′″ in a plan view. Likewise, in the contact 25′″, a fourth deformation portion 31′″ extends back from the back end of the contact portion 32 and a third deformation portion 30′″ extends diagonally forward left from the back end of the fourth deformation portion 31′″ in a plan view. In a side view of the contact 25′″, the first deformation portion 27′″, the second deformation portion 28′″, the third deformation portion 30′″, and the fourth deformation portion 31′″ extend diagonally down from the contact portion 32 side to the bottom plate portion 64 side.

Each of the contacts 25′, 25″, and 25′″ according to these modifications has a double-support structure, with the first elastic deformation portion 26′, 26″, or 26′″ and the second elastic deformation portion 29′, 29″, or 29′″ being not in a shape simply extending in the front-back direction (a simple linear shape). The same advantageous effects as the foregoing embodiment can thus be achieved.

When any of the contacts 25′, 25″, and 25′″ is in the free state, the entire first elastic deformation portion and second elastic deformation portion may be in one horizontal plane.

The end of each of the first elastic deformation portion and second elastic deformation portion of any of the contacts 25′, 25″, and 25′″ opposite to the contact portion 32 may be fixed to the bottom plate portion 64 (support portion).

The disclosed technique may be applied to a memory card connector for the insertion/removal of a memory card other than the SIM card SC (e.g. a microSD card).

The memory card connector 10 may be included in a device other than a mobile terminal (e.g. a PDA, a personal computer, a digital camera, or a digital video camera).

### INDUSTRIAL APPLICABILITY

A memory card connector according to the disclosure can be widely used in devices such as mobile terminals and smart devices, as a connector for a memory card or a SIM card.

### REFERENCE SIGNS LIST

10 memory card connector
15 lower housing
16 metal integral member
17 left portion constituent piece
18 right portion constituent piece
19 first contact block
20 right fixed portion (fixed portion) (support portion)
21 support protrusion piece
22 left fixed portion (fixed portion) (support portion)
23 support protrusion piece
25, 25′, 25″, 25′″ contact
26, 26′, 26″, 26′″ first elastic deformation portion
27, 27′, 27″, 27′″ first deformation portion
28, 28′, 28″, 28′″ second deformation portion
29, 29′, 29″, 29′″ second elastic deformation portion
30, 30′, 30″, 30′″ third deformation portion
31, 31′, 31″, 31′″ fourth deformation portion
32 contact portion
33 contact projection
35 tail connection piece
36 tail piece
38 second contact block
39 right fixed portion (fixed portion) (support portion)
40 left fixed portion (fixed portion) (support portion)
41 tail connection piece
43 third contact block
44 right fixed portion (fixed portion) (support portion)
45 left fixed portion (fixed portion) (support portion)
46 tail connection piece
48 fourth contact block
49 right fixed portion (fixed portion) (support portion)
50 left fixed portion (fixed portion) (support portion)
51 tail connection piece
53 fifth contact block
54 right fixed portion (fixed portion) (support portion)
55 left fixed portion (fixed portion) (support portion)
56 tail connection piece
58 sixth contact block
59 right fixed portion (fixed portion) (support portion)
60 left fixed portion (fixed portion) (support portion)
61 tail connection piece
63 insulator
64 bottom plate portion (support portion)
65 bottom through hole
66 side wall
67 back wall
68 card storage space
69 lock spring storage groove
70 first detection spring storage groove
71 second detection spring storage groove
73 lock spring
74 lock portion
75 first detection spring
76 contact piece
77 pressed protrusion
78 second detection spring
79 contact piece
80 shell member
CB circuit board
SC SIM card (memory card)
SC1 terminal
SC2 engagement recess

1. A memory card connector comprising:
a resin insulator having a card storage space into which a memory card is insertable along a linear direction and from which the memory card is removable along the linear direction, and a bottom plate portion forming a bottom surface of the card storage space; and
a metal contact having a contact portion that comes into contact with a terminal of the memory card inserted in the card storage space and at least a part of which is located in the card storage space above the bottom plate portion, and a pair of elastic deformation portions each of which has one end connected to the contact portion and an other end supported by a support portion that is formed by the bottom plate portion or by a fixed portion fixed to the bottom plate portion,
wherein in one of the pair of elastic deformation portions, the other end is located more in a direction in which the memory card is inserted than the one end, and at least a part is different in position from the contact portion in a direction orthogonal to the linear direction and a thickness direction of the memory card, and
in an other one of the pair of elastic deformation portions, the other end is located more in a direction in which the memory card is removed than the one end, and at least a part is different in position from the contact portion in the orthogonal direction.

2. The memory card connector according to claim 1,
wherein the contact portion is elastically deformable in the thickness direction of the memory card.

3. The memory card connector according to claim 1,
wherein the contact portion extends along the linear direction when seen in the thickness direction of the memory card.

4. The memory card connector according to claim 3,
wherein both ends of the contact portion are each closer to the support portion than an intermediate portion of the contact portion in the linear direction.

5. The memory card connector according to claim 1,
wherein the one end of each of the pair of elastic deformation portions is separated from the support portion in the thickness direction of the memory card.

6. The memory card connector according to claim 1,
wherein the bottom plate portion has a bottom through hole,
a part of the contact is located in the bottom through hole, and
at least a part of the contact portion is located in the card storage space.

7. The memory card connector according to claim 1,
wherein the one of the pair of elastic deformation portions has a first deformation portion extending from the other end toward the contact portion in the direction in which the memory card is removed, and a second deformation portion extending from an end of the first deformation portion opposite to the other end in the orthogonal direction and having an end opposite to the first deformation portion forming the one end,
the other one of the pair of elastic deformation portions has a third deformation portion extending from the other end toward the contact portion in the direction in which the memory card is inserted, and a fourth deformation portion extending from an end of the third deformation portion opposite to the other end in the orthogonal direction and having an end opposite to the third deformation portion forming the one end, and
the second deformation portion is located more in the direction in which the memory card is removed, than the fourth deformation portion.
